(19) United States
(12) Patent Application Publication
(10) Pub. No.: US 2015/0162842 A1
(43) Pub. Date: Jun. 11, 2015

(54) Single stage power factor correction converter

(71) Applicant: Fuxiang Lin, Lidcombe (AU)

(72) Inventor: Fuxiang Lin, Lidcombe (AU)

(21) Appl. No.: 14/550,972

(22) Filed: Nov. 22, 2014

Related U.S. Application Data
(63) Continuation-in-part of application No. 13/773,358, filed on Feb. 21, 2013.

(51) Int. Cl. H02M 3/335

(52) U.S. Cl. CPC H02M 3/33523

(57) ABSTRACT

A single-stage power factor correction power supply has two transformers: a main transformer and an auxiliary transformer (forward transformer). The main transformer transfers energy form the primary circuit to the secondary circuit. The auxiliary transformer is used to correct input current waveform. An extra winding of the auxiliary transformer is used to reduce the voltage stress of the switch component. The advantage of this design over the two-stage power supply is that the voltage across the storage capacitor can be designed to be only slightly higher than the peak value of the rectified input voltage. Therefore, it uses less energy to correct input current waveform and results in less of an Electromagnetic Compatibility (EMC) problem because it has a lower input current amplitude through the inductor than that of the two-stage PFC power supply. It increases power supply unit reliabilty and efficiency.

The present invention relates to a power converter, and more particularly, to a power factor correction (PFC) converter in a single stage.

### DESCRIPTION OF THE RELATED ART

Power converters have widely served to convert an unregulated power source to a regulated voltage or current. A PFC (Power Factor Correction) technique is applied to make an input current follow the waveform of an input voltage. Adding a PFC stage to the front end of a power converter substantially avoids unnecessary power loss and heat dissipation in a power contribution system.

A tranditional PFC power converter has two stages. A first stage is PFC stage, which includes an inductor, a rectifier and a transistor which is driven by a PFC control signal from the PFC stage. A second stage includes a transistor controlled by a control signal PWM, a transformer and a secondary circuitry, thus output voltage is regulated and output ripple noise is reduced. However, the PFC stage configuration increases the cost and the device counts of the converter, and hence the efficiency of power converter is reduced. Therefore, the development trend of a power converter is to build a single stage power converter with PFC function. The newly proposed topology of a single stage PFC power supply uses two transformers as FIG. 1: one forward transformer and one main transformer. The forward transformer transfers energy from its first winding to its second winding to correct the input current waveform, the main transformer transfers energy from the primary circuit to the secondary circuitry—output circuit (FIG. 4 in PCT—CN2012000948). This topology simplifies the control circuits by using one switch and one control circuit, and at the same time, it improves the efficiency of the power converter compared to the two stage PFC power converter, but adding a forward transformer to a power supply unit increases voltage stress of the switching component.

The present invention provides a simple method by adding an extra winding of the forward transformer and a diode to reduce voltage stress of the switching component of the power supply unit. The present invention also provides a method to recover the energy stored in the leaking inductance of the primary winding of the main transformer and to improve the converter efficiency. The present invention can further provide a power converter operating in lower stress to obtain higher reliability.

### SUMMERY OF THE INVENTION

The first objective of the present invention is to provide a switching power supply that operates from AC line voltage and has power factor correction and output isolation.

The second objective of the present invention is to provide a one stage power factor correction in an AC to DC converter.

The third objective of the present invention is to provide a simple circuit of PFC power supply to reduce the manufacture cost.

The fourth objective of the present invention is to provide a more efficient PFC power supply circuit.

Further objects and advantages of the present invention will be apparent from the following detailed description of a presently preferred embodiment, which is illustrated, schematically, in the accompanying drawings.

### BRIEF DESCRIPTION OF THE FIGURES

FIG. 1 is a schematic diagram of the prior art (FIG. 4 in PCT—CN201200948).

FIG. 2 is a schematic diagram of the present invention of a single stage power factor correction converter.

FIG. 3 is another schematic diagram of the present invention of a single stage power factor correction converter.

FIG. 4 is a secondary circuit of a fly-back converter in accordance with the present invention.

FIG. 5 is a secondary circuit of a forward converter in accordance with the present invention.

FIG. 6 is an input current waveform of a 50w a fly-back converter of present invention prototype.

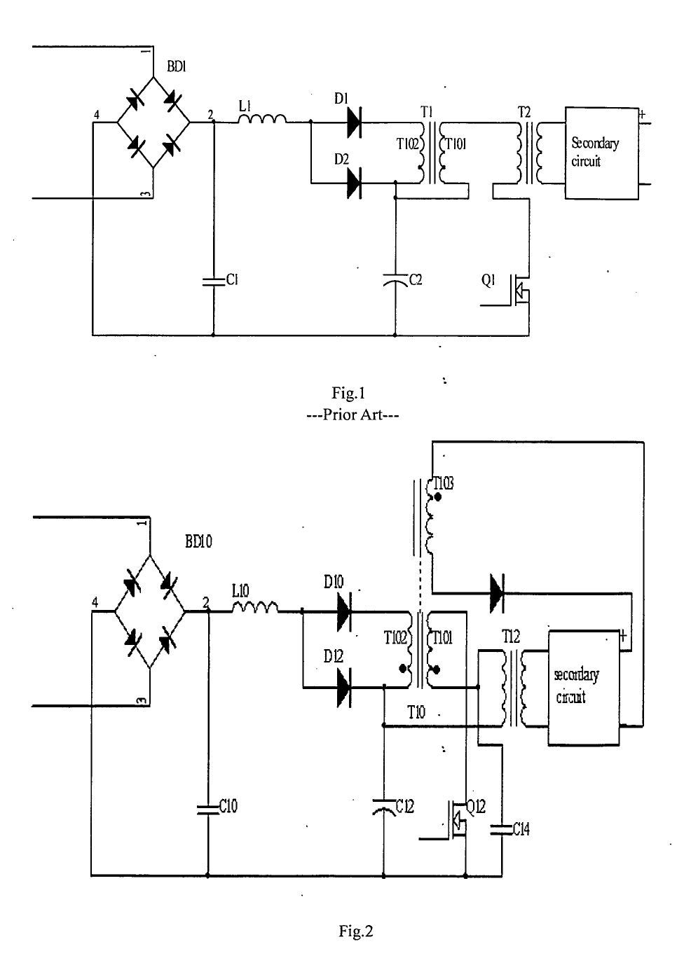

### DESCRIPTION OF THE PREFERRED EMBODIMENT

Before explaining the disclosed embodiment of the present invention in detail, it is to be understood that the invention is not limited in its application to the details of the particular arrangements shown since the invention is capable of other embodiments. The topology of the present invention is that a forward transformer's first winding is connected in series with a main transformer's primary winding and an extra winding of the forward transformer connected with a diode is coupled to output terminals. The main transformer transfers power from the primary circuit to the secondary circuit and the forward transformer transfers power to its second winding of the forward transformer to correct the input current waveform. The adding of an extra winding of the forward transformer and a diode is used to reduce the voltage stress of the switching component of a converter.

Refer to FIG. 2:

It illustrates the circuit diagram of a single switch power factor correction fly-back converter or a single switch power factor correction forward converter according to the present invention. The circuit is configured as following:

A full bridge rectifier BD10 has output terminals (a positive terminal and a negative terminal) and input terminals which are coupled to AC power lines.

A first capacitor C10 is coupled to the output terminals of the full bridge rectifier BD10.

An inductor L10 has a second terminal and a first terminal which is coupled to the positive output terminal of the full bridge rectifier BD10.

A first diode D10 has a cathode and an anode which is coupled to the second terminal of the inductor L10.

A second diode D12 has a cathode and an anode which is coupled to the second terminal of the inductor L10.

A forward transformer T10 has three windings: a first winding T101, a second winding T102 and a third winding T103. The second winding T102 has a first terminal which is coupled to the cathode of the first diode D10 and a second terminal which is coupled to the cathode of the second diode D12. The second terminals of the three winding of the forward transformer have the same polarity.

A second capacitor C12 has a positive terminal and a negative terminal. The positive terminal is coupled to the second terminal of the second winding T102 of the forward transformer T10 and the negative terminal is coupled to the negative output of the full bridge rectifier BD10.

A secondary circuitry has a positive output terminal and a negative output terminal.

A main transformer T12 has two windings: a primary winding and a secondary winding. The primary winding of the main transformer has a first terminal which is coupled to the positive terminal of the second capacitor C12 and a second terminal which is coupled to a second terminal of the first winding T101 of the forward transformer T10.The secondary winding of the main transformer T12 is coupled to a secondary circuitry. The main transformer T10 can be a fly-back transformer or a forward transformer.

A switch has three terminals: a first terminal, a second terminal and a control terminal.

The first terminal is coupled to the first terminal of the first winding T101 of the forward transformer T10. The second terminal of the switch is coupled to the negative output of the bridge rectifier BD10. The control terminal is coupled to a PWM control signal.

A third diode has a cathode which is coupled to the positive output of the secondary circuitry and an anode which is coupled to a first terminal of the third winding T103 of the forward transformer T10. The second terminal of the third winding T103 of the forward transformer is coupled to the negative output terminal of the secondary circuitry.

A third capacitor C14 has a first terminal which is coupled to the second terminal of the primary winding of the main transformer T12 and a second terminal which is coupled to the negative output of the bridge-rectifier BD10.

The Operation of the FIG. 2 is Following:

When switch Q10 is on, a current discharged from the capacitor C14 conducts through the first winding T101 of the forward transformer T10 and the switch Q10; a current drawn from the second capacitor C12 conducts through the primary winding of the main transformer T12 and the first winding T101 of the forward transformer T10; at the same time, there is an induced voltage in the second winding T102 of the forward transformer T10, therefore, there is a current drawn from the input to the second capacitor C12 (charging the second capacitor C12) through the inductor L10, the first diode D10 and the second winding T102 of the forward transformer T10. When switch Q10 is off, there is an induced voltage in the inductor L10, this voltage and input voltage force a current to charge the second capacitor C12 through the inductor L10 and the second diode D12. The energy stored in the leaking inductance of the primary winding of the main transformer T12 is released to the third capacitor C14. The energy stored in the forward transformer is released to the secondary circuitry through the third winding T103 of the forward transformer T10 and the third diode D14 and the induced voltage across the first winding of the forward transformer is reduced to ratio of the output voltage of the secondary circuitry, so that the voltage stress of the switch Q10 is reduced.

The number of the windings of the second winding of the forward transformer T10 is about two times of that of the first winding of the forward transformer T10. The number of the windings of the third winding of the forward transformer T10 is less than half of that of the first winding of the forward transformer, depending on the voltage of the output of the secondary circuitry.

The number of the windings of the first winding T101 of the forward transformer T10 and the value of the inductor L10 are adjusted to a certain value to correct the input current waveform in the best shape.

The circuit, comprising of the second winding T102 of the forward transformer T10, the inductor L10, the second capacitor C12, the first diode D10 and the second diode D12, can have numerous different arrangements. These arrangements have the same working principles. For example, the inductor L10 can be coupled between the negative terminal of the second capacitor C12 and the negative output terminal of the full bridge rectifier BD10. The anodes of the first diode D10 and the second diode D12 are coupled to the positive output terminal of the full bridge rectifier BD10. The second winding T102 of the forward transformer T10 is coupled between the cathode of the first diode D10 and the junction of the cathode of the second diode D12 and the positive terminal of the second capacitor C12.

The control signal can be a PWM or a PFM signal.

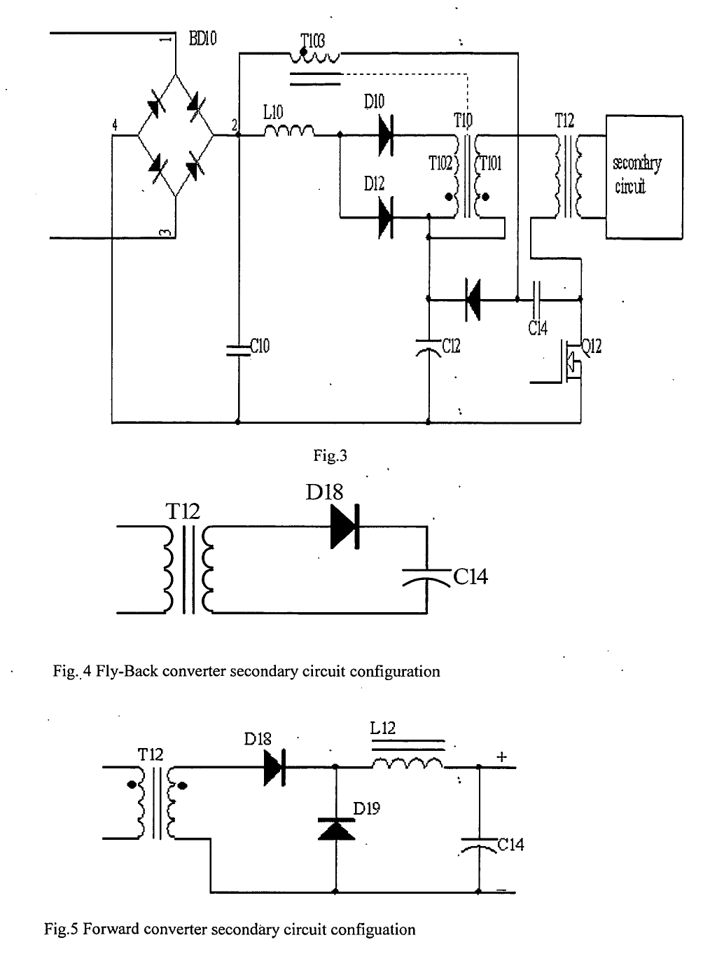

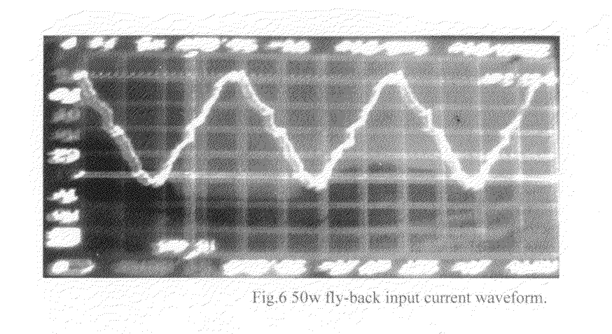

Refer to FIG. 3

It is another circuit diagram of a single switch power factor correction fly-back converter or a single switch power factor correction forward converter according to the present invention. The circuit is configured as following:

A full bridge rectifier BD10 has output terminals (a positive terminal and a negative terminal) and input terminals which are coupled to AC power lines.

A first capacitor C10 is coupled to the output terminals of the full bridge rectifier BD10.

An inductor L10 has a second terminal and a first terminal which is coupled to the positive output terminal of the full bridge rectifier BD10.

A first diode D10 has a cathode and an anode which is coupled to the second terminal of the inductor L10.

A second diode D12 has a cathode and an anode which is coupled to the second terminal of the inductor L10.

A forward transformer T10 has three windings: a first winding T101, a second winding T102 and a third winding T103. The second winding T102 has a first terminal which is coupled to the cathode of the first diode D10 and a second terminal which is coupled to the cathode of the second diode D12. A second terminal of the third winding T103 of the forward transformer T10 is coupled to positive output of the bridge rectifier BD10. The second terminals of the three windings of the forward transformer have the same polarity.

A second capacitor C12 has a positive terminal and a negative terminal. The positive terminal is coupled to the second terminals of the second winding T102 and the first winding T101 of the forward transformer T10. The negative terminal of the second capacitor C12 is coupled to the negative output of the full bridge rectifier BD10.

A main transformer T12 has two windings: a primary winding and a secondary winding. The primary winding of the main transformer has a first terminal which is coupled to the first terminal of the first winding T101 of the forward transformer T10 and a second terminal. The secondary winding of the main transformer is coupled to a secondary circuitry.

The main transformer can be a fly-back transformer or a forward transformer.

A switch Q10 has three terminals: a first terminal, a second terminal and a control terminal. The first terminal of the switch is coupled to the second terminal of the primary winding of the main transformer T12. The second terminal of the switch is coupled to the negative output of the bridge rectifier BD10. The control terminal of the switch is coupled to a PWM control signal.

A third diode D14 has an anode which is coupled to the first terminal of the third winding T103 of the forward transformer T10 and a cathode which is coupled to positive terminal of the second capacitor C12.

A third capacitor C14 has a first terminal which is coupled to the second terminal of the primary winding of the main transformer T12 and a second terminal which is coupled to the anode of the third diode D14 and the first terminal of the third winding T103 of the forward transformer T10.

The Operating Principle as Following Refer to FIG. 3

When switch Q10 is on, a current from the input conducts through the third winding T103 of the forward transformer T10, the capacitor C14 and the switch Q10; a current drawn from the second capacitor C12 conducts through the first winding T101 of the forward transformer T10, the primary winding of the main transformer T12 and the switch Q10. At the same time there is an induced voltage in the second winding T102 of the forward transformer T10, therefore, there is a current drawn from the input to the second capacitor C12 (charging the second capacitor C12) through the inductor L10, the first diode D10 and the second winding T102 of the forward transformer T10. When switch Q10 is off, there is an induced voltage in the inductor L10, this voltage and input voltage force a current to charge the second capacitor C12 through the inductor L10 and the second diode D12. The energy stored in the leaking inductance of the primary winding of the main transformer T12 is released to the third capacitor C14. The energy stored in the forward transformer is released to the second second capacitor C12 through the third winding T103 of the forward transformer T10 and the third diode D14 and the induced voltage across the first winding T101 of the forward transformer T10 is reduced, so that the voltage stress of the switch Q10 is reduced. The number of the windings of the second winding of the forward transformer T10 is about two times of that of the first winding T101 of the forward transformer T10. The number of the windings of the third winding T103 of the forward transformer T10 is about one and half times of that of the first winding T101 of the forward transformer.

The number of the windings of the primary winding T101 of the forward transformer T10 and the value of the inductor L10 are adjusted to a certain value to correct the input current waveform in the best shape.

The circuit, comprising of the second winding T102 of the forward transformer T10, the inductor L10, the second capacitor C12, the first diode D10 and the second diode D12, can have numerous different arrangements. These arrangements have the same working principles. For example, the inductor L10 can be coupled between the negative terminal of the second capacitor C12 and the negative output terminal of the full bridge rectifier BD10. The anodes of the first diode D10 and the second diode D12 are coupled to the positive output terminal of the full bridge rectifier BD10. The second winding T102 of the forward transformer T10 is coupled between the cathode of the first diode D10 and the junction of the cathode of the second diode D12 and the positive terminal of the second capacitor C12.

The third capacitor C14 can be not employed and use a snubber circuit instead.

The control signal can be a PWM or a PFM signal.

The above-described embodiments of the present invention are intended to be illustrative only. Numerous alternative embodiments may be devised by those skilled in the art without departing from the scope of the following claims.

What is claimed is:

1. A single-stage power factor correction converter comprising of:
A full bridge rectifier having:
output terminals, wherein said a positive terminal and a negative terminal; and
input terminals, wherein said being coupled to input power lines;
A first capacitor wherein said coupled to the output terminals of the full bridge rectifier;
An inductor having:
a first terminal, wherein said being coupled to the positive output of the rectifier; and
a second terminal;
A first diode having:
a cathode and
an anode, wherein said being coupled to the second terminal of the inductor;
A second diode having:
a cathode; and
an anode, wherein said being coupled to the second terminal of the inductor;
A third diode having:
an cathode and
an anode;
A main transformer comprising:
a primary winding, wherein said having a first terminal which is coupled the cathode of the second diode and a second terminal; and
a secondary winding, wherein said being coupled to a secondary circuitry which has a positive output terminal and a negative output terminal;
wherein said the main transformer is a fly-back transformer or a forward transformer;
A forward transformer comprising:
a first winding, wherein said having a first terminal and a second terminal which is coupled to the second terminal of the primary winding of the main transformer; and
a second winding wherein said having a first terminal which is coupled to the cathode of the first diode and a second terminal which is coupled to the cathode of the second diode; and
a third winding, wherein said having a first terminal which is coupled to the anode of the third diode and a second terminal which is coupled to the negative output of the secondary circuitry, and wherein said the cathode of the third diode is coupled to the positive output terminal of the secondary circuitry;
wherein said the second terminals of the three windings of the forward transformer having the same polarity;
A second capacitor having:
a positive terminal, wherein said being coupled to the first terminal of the primary winding of the main transformer and the cathode of the second diode; and
a negative terminal, wherein said being coupled to the negative output of the full bridge rectifier.
A switch having:
a first terminal, wherein said being coupled to the first terminal of the first winding of the forward transformer; and
a second terminal wherein being coupled to the negative output of the bridge rectifier; and
a control terminal, wherein said being coupled to the PWM control signal;
A third capacitor having:
a first terminal, wherein said being coupled to the second terminal of the main transformer; and
a second terminal, wherein said being coupled to the negative output of the bridge rectifier.

2. A single-stage power factor correction converter in claim 1, wherein said the first winding of the forward transformer is connected in series with the primary winding of the main transformer, the energy through the first winding of the forward transformer is used to correct the input current waveform, the energy through the primary winding of the main transformer is transferred to the secondary winding of the main transformer.

3. A single-stage power factor correction converter in claim 1, wherein said the inductor is used to smooth the input current and to store the energy from the input power during the switch in conductive state.

4. A single-stage power factor correction converter in claim 1, wherein said the second winding of the forward transformer, which is coupled between the positive terminal of the second capacitor and the cathode of the first diode, is used to provide the voltage force to draw the input current to the second capacitor and to correct input current waveform.

5. A single-stage power factor correction converter in claim 1, wherein said the second diode, which is coupled between the second terminal of the inductor and the positive terminal of the second capacitor, is used to provide a mean to release the energy stored in the inductor during the switch in non-conductive state and to correct input current waveform.

6. A single-stage power factor correction converter in claim 1, wherein said a circuit of the third winding of the forward transformer and the third diode said coupled to and between the output terminals of the secondary circuitry, is employed to reduce the switch voltage stress.

7. A single-stage power factor correction converter in claim 1, wherein said the third capacitor, which is coupled to and between the second terminal of the main transformer and the negative output of the bridge rectifier, is used to capture energy stored in the leaking inductance of the primary winding of the main transformer, during the switch in a non-conductive state, and said to release captured energy through the first winding of the forward transformer, during the switch in a conductive state.

8. A single-stage power factor correction converter in claim 7, wherein said the third capacitor is able to be replaced by a snubber circuit comprising of a resistor, a capacitor and a diode.

9. A single-stage power factor correction converter in claim 1, wherein said there are numerous circuit arrangements of the second winding of the forward transformer, the first diode, the second diode, the second capacitor and the inductor.

10. A single-stage power factor correction converter comprising of:
A full bridge rectifier having:
output terminals, wherein said a positive terminal and a negative terminal; and
input terminals wherein said being coupled to input power lines;
A first capacitor wherein said being coupled to the output terminals of the full bridge rectifier;
An inductor having
a first terminal, wherein said being coupled to the positive output of the rectifier; and
a second terminal,
A first diode having
an anode, wherein said being coupled to the second terminal of the inductor; and
a cathode;
A second diode having
an anode, wherein said being coupled to the second terminal of the inductor; and
a cathode;
A third diode having
an anode and
a cathode;
A main transformer comprising
a primary winding wherein said having a first terminal and a second terminal, and
a secondary winding, wherein said being coupled to a secondary circuitry; and
wherein said the main transformer is a fly-back transformer or a forward transformer;
A forward transformer comprising:
a first winding, wherein said having a first terminal which is coupled to the first terminal of the primary winding of the main transformer and said the second terminal is coupled to the cathode of the second diode; and
a second winding, wherein said having a first terminal which said is coupled to the cathode of the first diode and a second terminal which said is coupled to the cathode of the second diode; and
a third winding, wherein said having a first terminal which is coupled to the anode of the third diode and a second terminal which is coupled to the positive output of the bridge rectifier; and
wherein said the second terminals of the three windings of the forward transformer having the same polarity;
A second capacitor having:
a positive terminal wherein said being coupled to the second terminal of the first winding of the forward transformer, the cathode of the second diode and the cathode of the third diode; and
a negative terminal, wherein said being coupled to the negative output of the full bridge rectifier.
A switch having
a first terminal, wherein said being coupled to the second terminal of the primary winding of the main transformer; and
a second terminal wherein said being coupled to the negative output of the bridge rectifier; and
a control terminal, wherein said being coupled to the PWM control signal;
A third capacitor having:
a first terminal, wherein said being coupled to the second terminal of the main transformer, and
a second terminal, wherein said being coupled to the anode of the third diode.

11. A single-stage power factor correction converter in claim 10, wherein said the third winding is used to released energy stored in forward transformer and to reduce voltage across the first winding of the forward transformer during the switch in non-conductive state.

12. A single-stage power factor correction converter in claim 10, wherein said the third capacitor is used to capture energy stored in leaking inductance of the primary winding of the main transformer during the switch in non-conductive state and releases its energy through the third winding of the forward transformer during the switch in conductive state.

13. A single-stage power factor correction converter in claim 10, wherein said there are numerous circuit arrangements of the second capacitor, the first diode, the second diode and the second winding of the forward transformer.
